(19) United States
(12) Patent Application Publication
(10) Pub. No.: US 2012/0069144 A1
(43) Pub. Date: Mar. 22, 2012

(54) METHOD FOR PERFORMING DISPLAY MANAGEMENT REGARDING A THREE-DIMENSIONAL VIDEO STREAM, AND ASSOCIATED VIDEO DISPLAY SYSTEM

(76) Inventors: Geng Li, Anhui Province (CN); Sheng-Nan Wang, Anhui Province (CN)

(21) Appl. No.: 13/130,055

(22) PCT Filed: Sep. 20, 2010
(86) PCT No.: PCT/CN10/77136

§ 371 Date: May 19, 2011

(51) Int. Cl. H04N 7/68; H04N 13/00

(52) U.S. Cl. 348/43; 348/E13.064; 375/E07.281

(57) ABSTRACT

A method for performing display management regarding a three-dimensional (3-D) video stream is provided, where the 3-D video stream includes a plurality of sub-streams respectively corresponding to two eyes of a user. The method includes: dynamically detecting whether video information corresponding to all of the sub-streams is displayable; and when it is detected that video information corresponding to a first sub-stream of the sub-streams is not displayable, temporarily utilizing video information corresponding to a second sub-stream of the sub-streams to emulate the video information corresponding to the first sub-stream. An associated video display system is also provided.

### FIELD OF INVENTION

The present invention relates to video display control of a three-dimensional (3-D) display system, and more particularly, to a method for performing display management regarding a 3-D video stream, and to an associated video display system.

### BACKGROUND OF THE INVENTION

According to the related art, a conventional video display system such as a conventional Digital Versatile Disc (DVD) player may skip some images of a video program when errors (e.g. uncorrectable errors) of decoding the images occur, in order to prevent erroneous display of the images. Typically, in a situation where only a few images are skipped, a user is not aware of the skipping operations of the DVD player. However, in a situation where a lot of images are skipped due to too many errors, the user may feel an abrupt jump of the video program, giving the user a bad viewing experience.

Please note that the conventional video display system does not serve the user well. Thus, a novel method is required for reducing the number of skipping operations of a video display system.

### SUMMARY OF THE INVENTION

It is therefore an objective of the claimed invention to provide a method for performing display management regarding a three-dimensional (3-D) video stream, and to provide an associated video display system, in order to prevent skipping operations such as those mentioned above and/or to reduce the number of skipping operations.

It is another objective of the claimed invention to provide a method for performing display management regarding a 3-D video stream, and to provide an associated video display system, in order to keep displaying when errors occur and to utilize at least one emulated image as a substitute of at least one erroneous image.

An exemplary embodiment of a method for performing display management regarding a 3-D video stream is provided, where the 3-D video stream comprises a plurality of sub-streams respectively corresponding to two eyes of a user. The method comprises: dynamically detecting whether video information corresponding to all of the sub-streams is displayable; and when it is detected that video information corresponding to a first sub-stream of the sub-streams is not displayable, temporarily utilizing video information corresponding to a second sub-stream of the sub-streams to emulate the video information corresponding to the first sub-stream.

An exemplary embodiment of an associated video display system comprises a processing circuit arranged to perform display management regarding a 3-D video stream, wherein the 3-D video stream comprises a plurality of sub-streams respectively corresponding to two eyes of a user. The processing circuit comprises a detection module and an emulation module. In addition, the detection module is arranged to dynamically detect whether video information corresponding to all of the sub-streams is displayable. Additionally, when it is detected that video information corresponding to a first sub-stream of the sub-streams is not displayable, the emulation module temporarily utilizes video information corresponding to a second sub-stream of the sub-streams to emulate the video information corresponding to the first sub-stream.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a video display system according to a first embodiment of the present invention.

FIG. 2 is a flowchart of a method for performing display management regarding a three-dimensional (3-D) video stream according to one embodiment of the present invention.

FIGS. 3A-3B illustrate a plurality of video contents involved with the method shown in FIG. 2 according to an embodiment of the present invention.

FIG. 4 is a diagram of a video display system according to a second embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

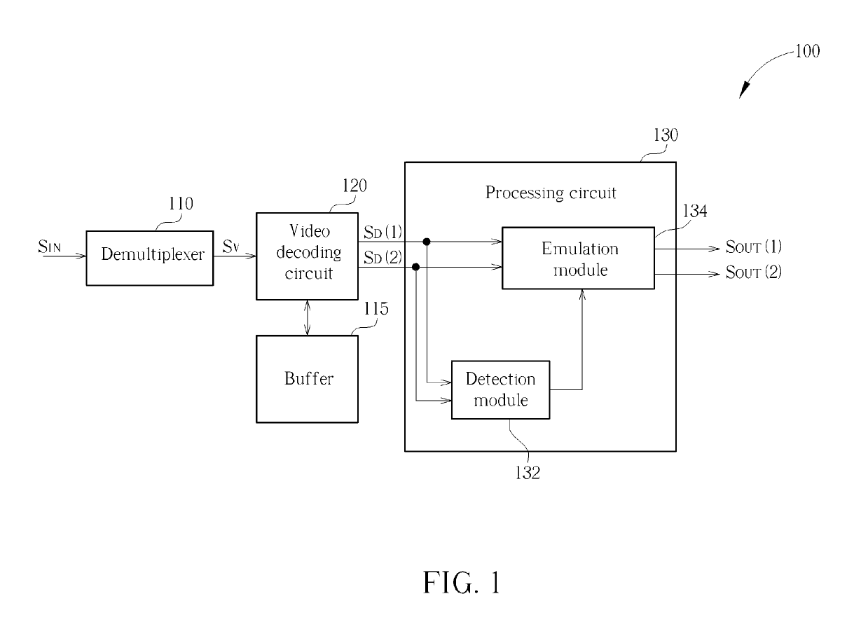

Please refer to FIG. 1, which illustrates a diagram of a video display system 100 according to a first embodiment of the present invention. As shown in FIG. 1, the video display system 100 comprises a demultiplexer 110, a buffer 115, a video decoding circuit 120, and a processing circuit 130, where the processing circuit 130 comprises a detection module 132 and an emulation module 134. In practice, the buffer 115 can be positioned outside the video decoding circuit 120. This is for illustrative purposes only, and is not meant to be a limitation of the present invention. According to a variation of this embodiment, the buffer 115 can be integrated into the video decoding circuit 120. According to another variation of this embodiment, the buffer 115 can be integrated into another component within the video display system 100.

In addition, the video display system 100 of this embodiment can be implemented as an entertainment device that is capable of accessing data of a video program and inputting an input data stream S_{IN} into a main processing architecture within the video display system 100, such as that shown in FIG. 1, where the input data stream S_{IN} carries the data of the video program. Please note that, according to this embodiment, the entertainment device mentioned above is taken as an example of the video display system 100. This is for illustrative purposes only, and is not meant to be a limitation of the present invention. According to a variation of this embodiment, the video display system 100 can be implemented as an optical storage device such as a Blu-ray Disc (BD) player. According to some variations of this embodiment, the video display system 100 can be implemented as a digital television (TV) or a digital TV receiver, and comprises a digital tuner (not shown) for receiving broadcasting signals to generate the input data stream S_{IN} such as a TV data stream of the video program.

In this embodiment, the demultiplexer 110 is arranged to demultiplex the input data stream S_{IN} into a video data stream S_{V} and an audio data stream S_{A} (not shown in FIG. 1). The video decoding circuit 120 decodes the video data stream S_{V} to generate one or more images of the video program, where the buffer 115 is arranged to temporarily store the images of the video program. Please note that the input data stream S_{IN} can be a data stream of a two-dimensional (2-D) video program or a data stream of a three-dimensional (3-D) video program. Some implementation details respectively corresponding to different situations are described as follows.

In a situation where the input data stream S_{IN} is the data stream of the 2-D video program, the video data stream S_{V} can be a 2-D video stream, and the processing circuit 130 operates in a 2-D mode, where the notation S_{D}(1) can be utilized for representing a decoded signal of the video data stream S_{V}, and the path(s) corresponding to the notation S_{D}(2) can be ignored in this situation. In addition, the processing circuit 130 is arranged to perform display management regarding the 2-D video stream. As a result, the processing circuit 130 generates an output signal S_{OUT}(1) that carries the images to be displayed, where the path corresponding to the notation S_{OUT}(2) can be ignored in this situation.

More specifically, the detection module 132 of this embodiment can detect whether one or more errors (and more particularly, uncorrectable errors) of decoding the images occur. First, suppose that no error occurs. Typically, if no additional processing is required, the processing circuit 130 can output the decoded signal S_{D}(1) as the output signal S_{OUT}(1); otherwise, the processing circuit 130 may apply a certain processing to the decoded signal S_{D}(1) to generate the output signal S_{OUT}(1). When the aforementioned one or more errors occur, the detection module 132 notifies the emulation module 134 of the occurrence of the errors. As a result, the emulation module 134 emulates at least one image according to some non-erroneous images corresponding to different time points, and utilizes the at least one emulated image as a substitute of at least one erroneous image. Please note that although the emulated image(s) may be not so real, when there are too many erroneous images, utilizing the associated emulated images as substitutes of the erroneous images may achieve a better effect than that of skipping the erroneous images since nobody likes an abrupt jump of the 2-D video program.

In a situation where the input data stream S_{IN} is the data stream of the 3-D video program, the video data stream S_{V} can be a 3-D video stream, and the processing circuit 130 operates in a 3-D mode, where the 3-D video stream may comprise a plurality of sub-streams respectively corresponding to two eyes of a user. In particular, the sub-streams correspond to predetermined view angles of the two eyes of the user, respectively. For example, the notations S_{D}(1) and S_{D}(2) can be utilized for representing decoded signals of two sub-streams S_{SUB}(1) and S_{SUB}(2) within the video data stream S_{V}. In addition, the processing circuit 130 is arranged to perform display management regarding the 3-D video stream. As a result, the processing circuit 130 generates two output signals S_{OUT}(1) and S_{OUT}(2) that carry the images for the two eyes of the user, respectively.

More specifically, the detection module 132 of this embodiment can detect whether one or more errors (and more particularly, uncorrectable errors) of decoding the images occur. First, suppose that no error occurs. Typically, if no additional processing is required, the processing circuit 130 can output the decoded signals S_{D}(1) and S_{D}(2) as the output signals S_{OUT}(1) and S_{OUT}(2), respectively; otherwise, the processing circuit 130 may apply a certain processing to the decoded signals S_{D}(1) and S_{D}(2) to generate the output signals S_{OUT}(1) and S_{OUT}(2), respectively. When the aforementioned one or more errors occur, the detection module 132 notifies the emulation module 134 of the occurrence of the errors. As a result, the emulation module 134 emulates at least one image according to some non-erroneous images corresponding to other time points and/or according to some non-erroneous images corresponding to different paths, and utilizes the at least one emulated image as a substitute of at least one erroneous image. For example, the emulation module 134 may emulate at least one image for the left eye of the user according to some non-erroneous images for the right eye of the user, and may emulate at least one image for the right eye of the user according to some non-erroneous images for the left eye of the user. In another example, the emulation module 134 may emulate images for the two eyes of the user according to some non-erroneous images for the left and/or right eyes of the user, where the non-erroneous images may correspond to different time points. Please note that although the emulated image(s) may be not so real, when there are too many erroneous images, utilizing the associated emulated images as substitutes of the erroneous images may achieve a better effect than that of skipping the erroneous images since nobody likes an abrupt jump of the 3-D video program.

Please note that the detection module 132 is arranged to detect based upon one or more of the decoded signals S_{D}(1) and S_{D}(2). This is for illustrative purposes only, and is not meant to be a limitation of the present invention. According to a variation of this embodiment, the detection module 132 can be arranged to detect based upon one or more of the two sub-streams S_{SUB}(1) and S_{SUB}(2). According to another variation of this embodiment, the detection module 132 can be arranged to detect based upon the video data stream S_{V}.

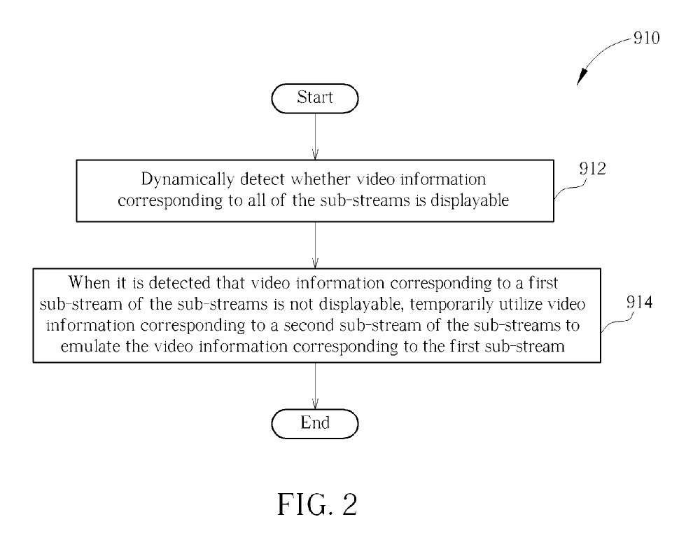

Based upon the architecture of the first embodiment or any of its variations disclosed above, the video display system 100 can properly emulate at least one image to prevent the related art problem. Some implementation details are further described according to FIG. 2.

FIG. 2 is a flowchart of a method 910 for performing display management regarding a 3-D video stream such as that mentioned above according to one embodiment of the present invention. The method 910 shown in FIG. 2 can be applied to the video display system 100 shown in FIG. 1. More particularly, given that the processing circuit 130 can operate in the aforementioned 3-D mode, the method 910 can be implemented by utilizing the video display system 100. The method is described as follows.

In Step 912, the detection module 132 dynamically detects whether video information corresponding to all of the sub-streams is displayable. In particular, the video information corresponding to all of the sub-streams comprises first decoded data corresponding to the first sub-stream, and further comprises second decoded data corresponding to the second sub-stream. For example, the first sub-stream can be the aforementioned sub-stream S_{SUB}(1) and the second sub-stream can be the aforementioned sub-stream S_{SUB}(2), where the first decoded data is carried by the decoded signal S_{D}(1) of the sub-stream S_{SUB}(1), and the second decoded data is carried by the decoded signal S_{D}(2) of the sub-stream S_{SUB}(2). In practice, the detection module 132 can dynamically detect whether both the first decoded data and the second decoded data mentioned above are displayable, in order to determine whether the video information corresponding to all of the sub-streams (e.g. the sub-streams S_{SUB}(1) and S_{SUB}(2)) is displayable.

In Step 914, when it is detected that video information corresponding to a first sub-stream of the sub-streams (e.g. the video information corresponding to the sub-stream S_{SUB}(1)) is not displayable, the emulation module 134 temporarily utilizes video information corresponding to a second sub-stream of the sub-streams (e.g. the video information corresponding to the sub-stream S_{SUB}(2)) to emulate the video information corresponding to the first sub-stream. For example, when it is detected that the video information corresponding to the first sub-stream is not displayable (e.g. the first decoded data is not displayable), the emulation module 134 can temporarily utilize the second decoded data to emulate the first decoded data.

According to this embodiment, in order to determine whether the video information corresponding to all of the sub-streams is displayable, the detection module 132 can dynamically detect whether both the first decoded data and the second decoded data mentioned above are displayable. This is for illustrative purposes only, and is not meant to be a limitation of the present invention. According to a variation of this embodiment, the detection module 132 can dynamically detect whether data carried by the first sub-stream and data carried by the second sub-stream are complete, in order to determine whether the video information corresponding to all of the sub-streams is displayable. More particularly, when a portion of the data carried by the first sub-stream is missing, the detection module 132 can determine that the video information corresponding to the first sub-stream is not displayable.

According to another variation of this embodiment, the detection module 132 can dynamically detect whether both the first sub-stream and the second sub-stream exist, in order to determine whether the video information corresponding to all of the sub-streams is displayable. More particularly, when the first sub-stream does not exist, the detection module 132 can determine that the video information corresponding to the first sub-stream is not displayable.

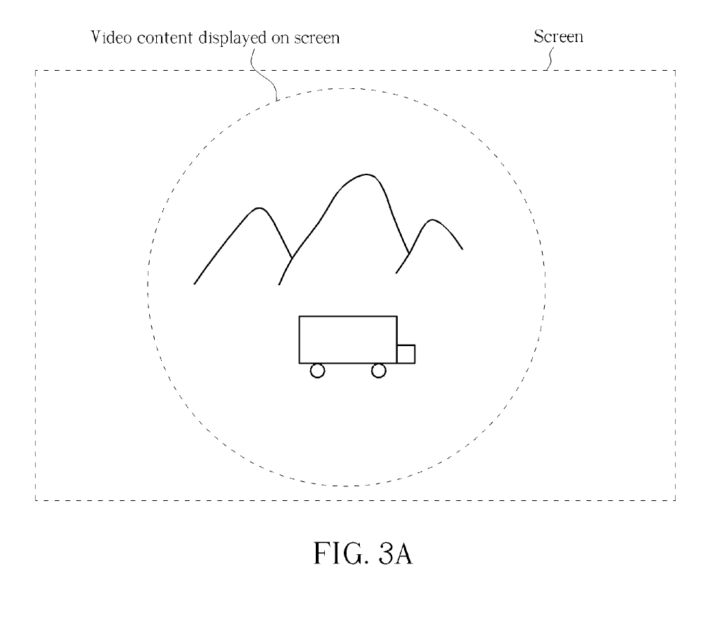

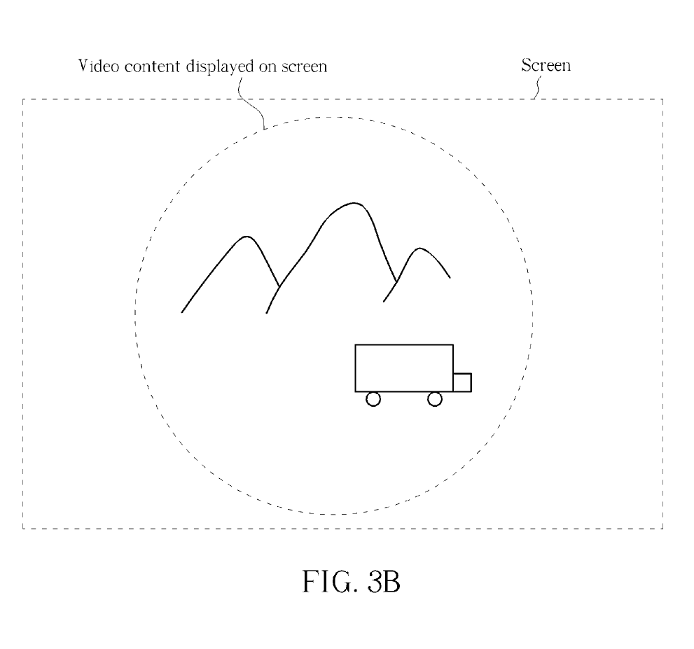

FIGS. 3A-3B illustrate a plurality of video contents involved with the method 910 shown in FIG. 2 according to an embodiment of the present invention. As mentioned, the sub-streams correspond to the predetermined view angles of the two eyes of the user, respectively. Within the screen shown in any of FIGS. 3A-3B, some video contents such as the mountains and the truck are illustrated, where the image shown in FIG. 3A is displayed for the right eye of the user, and the image shown in FIG. 3B is displayed for the left eye of the user.

According to this embodiment, based upon a difference between the predetermined view angles of the two eyes of the user, the emulation module 134 can temporarily utilize the video information corresponding to the second sub-stream of the sub-streams to emulate the video information corresponding to the first sub-stream. For example, given that the first sub-stream represents the aforementioned sub-stream S_{SUB}(1) and the second sub-stream represents the aforementioned sub-stream S_{SUB}(2), with the sub-streams S_{SUB}(1) and S_{SUB}(2) respectively corresponding to the right eye and the left eye, in a situation where the image shown in FIG. 3A is missing and Step 914 is executed, the emulation module 134 can copy the whole image shown in 3B and alter the location of the truck, in order to generate an image similar to that shown in FIG. 3A. Please note that the location of the truck is altered because the truck is a foregound video content. On the contrary, the locations of the mountains are not altered since the mountains are background video contents. Similar descriptions for this embodiment are not repeated in detail.

According to a variation of this embodiment, the emulation module 134 can temporarily apply a shift amount to the video information corresponding to the second sub-stream of the sub-streams to emulate the video information corresponding to the first sub-stream. For example, given that the first sub-stream represents the aforementioned sub-stream S_{SUB}(1) and the second sub-stream represents the aforementioned sub-stream S_{SUB}(2), with the sub-streams S_{SUB}(1) and S_{SUB}(2) respectively corresponding to the right eye and the left eye, in a situation where the image shown in FIG. 3A is missing and Step 914 is executed, the emulation module 134 can copy the whole image shown in 3B and apply a shift amount to the truck, in order to generate an image similar to that shown in FIG. 3A. Please note that the shift amount is applied to the truck because the truck is a foregound video content. On the contrary, no shift amount is applied to the mountains since the mountains are background video contents. Similar descriptions for this embodiment are not repeated in detail.

According to another variation of this embodiment, the emulation module 134 can temporarily apply a shift amount to a whole image corresponding to the second sub-stream of the sub-streams to emulate an image corresponding to the first sub-stream. For example, given that the first sub-stream represents the aforementioned sub-stream S_{SUB}(1) and the second sub-stream represents the aforementioned sub-stream S_{SUB}(2), with the sub-streams S_{SUB}(1) and S_{SUB}(2) respectively corresponding to the right eye and the left eye, in a situation where the image shown in FIG. 3A is missing and Step 914 is executed, the emulation module 134 can copy the whole image shown in 3B and apply a shift amount to the whole image, in order to generate an image similar to that shown in FIG. 3A. Please note that the shift amount is applied to all of the truck and the mountains for reducing the associated computation load of the procesing circuit 130. Similar descriptions for this embodiment are not repeated in detail.

According to another variation of this embodiment, the emulation module 134 can copy a whole image corresponding to the second sub-stream of the sub-streams to emulate an image corresponding to the first sub-stream, without altering any video content, in order to reduce the associated computation load of the procesing circuit 130 when Step 914 is executed. Similar descriptions for this embodiment are not repeated in detail.

According to an embodiment, the 3-D mode of the procesing circuit 130 may comprise a plurality of sub-modes, and the procesing circuit 130 may switch between the sub-modes, where the implementation details of the embodiment shown in FIGS. 3A-3B and its variations disclosed above are implemented in the sub-modes, respectively. For example, in a first sub-mode, based upon a difference between the predetermined view angles of the two eyes of the user, the emulation module 134 can temporarily utilize the video information corresponding to the second sub-stream of the sub-streams to emulate the video information corresponding to the first sub-stream. In addition, in a second sub-mode, the emulation module 134 can temporarily apply a shift amount to the video information corresponding to the second sub-stream of the sub-streams to emulate the video information corresponding to the first sub-stream. Additionally, in a third sub-mode, the emulation module 134 can temporarily apply a shift amount to a whole image corresponding to the second sub-stream of the sub-streams to emulate an image corresponding to the first sub-stream. In a fourth sub-mode, the emulation module 134 merely copies a whole image corresponding to the second sub-stream of the sub-streams to emulate an image corresponding to the first sub-stream, without altering any video content. Similar descriptions for this embodiment are not repeated in detail.

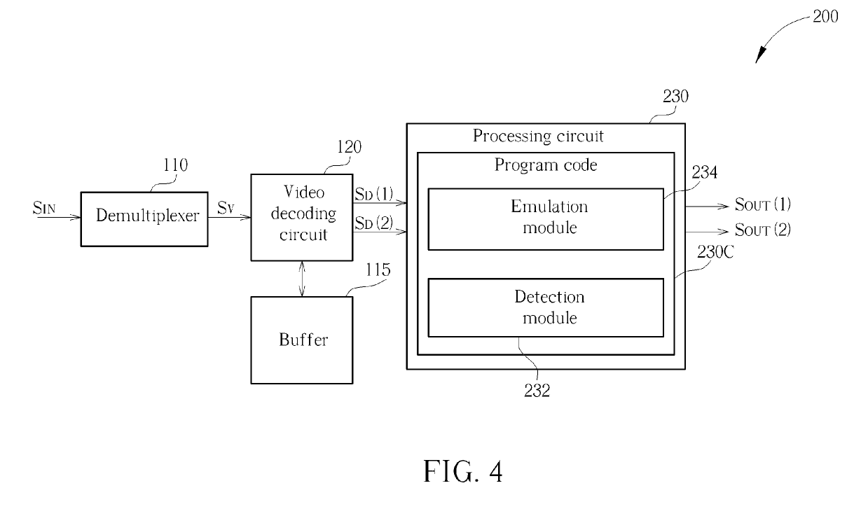

FIG. 4 is a diagram of a video display system 200 according to a second embodiment of the present invention. The differences between the first and the second embodiments are described as follows.

The processing circuit 130 mentioned above is replaced by a processing circuit 230 executing program code 230C, where the program code 230C comprises program modules such as a detection module 232 and an emulation module 234 respectively corresponding to the detection module 132 and the emulation module 134. In practice, the processing circuit 230 executing the detection module 232 typically performs the same operations as those of the detection module 132, and the processing circuit 230 executing the emulation module 234 typically performs the same operations as those of the emulation module 134, where the detection module 232 and the emulation module 234 can be regarded as the associated software/firmware representatives of the detection module 132 and the emulation module 134, respectively. Similar descriptions for this embodiment are not repeated in detail.

It is an advantage of the present invention that, based upon the architecture of the embodiments/variations disclosed above, the goal of utilizing at least one emulated image as a substitute of at least one erroneous image can be achieved. As a result, the number of skipping operations such as those mentioned above can be reduced, and more particularly, the skipping operations can be prevented. Therefore, the related art problem can no longer be an issue.

Those skilled in the art will readily observe that numerous modifications and alterations of the device and method may be made while retaining the teachings of the invention. Accordingly, the above disclosure should be construed as limited only by the metes and bounds of the appended claims.

1. A method for performing display management regarding a three-dimensional (3-D) video stream, the 3-D video stream comprising a plurality of sub-streams respectively corresponding to two eyes of a user, the method comprising:
dynamically detecting whether video information corresponding to all of the sub-streams is displayable; and
when it is detected that video information corresponding to a first sub-stream of the sub-streams is not displayable, temporarily utilizing video information corresponding to a second sub-stream of the sub-streams to emulate the video information corresponding to the first sub-stream.

2. The method of claim 1, wherein the video information corresponding to all of the sub-streams comprises first decoded data corresponding to the first sub-stream, and further comprises second decoded data corresponding to the second sub-stream.

3. The method of claim 2, wherein the step of dynamically detecting whether the video information corresponding to all of the sub-streams is displayable further comprises:
dynamically detecting whether both the first decoded data and the second decoded data are displayable.

4. The method of claim 2, wherein the step of temporarily utilizing the video information corresponding to the second sub-stream of the sub-streams to emulate the video information corresponding to the first sub-stream further comprises:
temporarily utilizing the second decoded data to emulate the first decoded data.

5. The method of claim 2, wherein the first decoded data is carried by a first decoded signal of the first sub-stream, and the second decoded data is carried by a second decoded signal of the second sub-stream.

6. The method of claim 1, wherein the step of dynamically detecting whether the video information corresponding to all of the sub-streams is displayable further comprises:
dynamically detecting whether data carried by the first sub-stream and data carried by the second sub-stream are complete.

7. The method of claim 1, wherein the step of dynamically detecting whether the video information corresponding to all of the sub-streams is displayable further comprises:
dynamically detecting whether both the first sub-stream and the second sub-stream exist.

8. The method of claim 1, wherein the sub-streams correspond to predetermined view angles of the two eyes of the user, respectively.

9. The method of claim 8, wherein the step of temporarily utilizing the video information corresponding to the second sub-stream of the sub-streams to emulate the video information corresponding to the first sub-stream further comprises:
based upon a difference between the predetermined view angles, temporarily utilizing the video information corresponding to the second sub-stream of the sub-streams to emulate the video information corresponding to the first sub-stream.

10. The method of claim 1, wherein the step of temporarily utilizing the video information corresponding to the second sub-stream of the sub-streams to emulate the video information corresponding to the first sub-stream further comprises:
applying a shift amount to the video information corresponding to the second sub-stream of the sub-streams to emulate the video information corresponding to the first sub-stream.

11. A video display system, comprising:
a processing circuit arranged to perform display management regarding a three-dimensional (3-D) video stream, wherein the 3-D video stream comprises a plurality of sub-streams respectively corresponding to two eyes of a user, and the processing circuit comprises:
a detection module arranged to dynamically detect whether video information corresponding to all of the sub-streams is displayable; and
an emulation module, wherein when it is detected that video information corresponding to a first sub-stream of the sub-streams is not displayable, the emulation module temporarily utilizes video information corresponding to a second sub-stream of the sub-streams to emulate the video information corresponding to the first sub-stream.

12. The video display system of claim 11, wherein the video information corresponding to all of the sub-streams comprises first decoded data corresponding to the first sub-stream, and further comprises second decoded data corresponding to the second sub-stream.

13. The video display system of claim 12, wherein the detection module dynamically detects whether both the first decoded data and the second decoded data are displayable.

14. The video display system of claim 12, wherein the emulation module temporarily utilizes the second decoded data to emulate the first decoded data.

15. The video display system of claim 12, wherein the first decoded data is carried by a first decoded signal of the first sub-stream, and the second decoded data is carried by a second decoded signal of the second sub-stream.

16. The video display system of claim 11, wherein the detection module dynamically detects whether data carried by the first sub-stream and data carried by the second sub-stream are complete.

17. The video display system of claim 11, wherein the detection module dynamically detects whether both the first sub-stream and the second sub-stream exist.

18. The video display system of claim 11, wherein the sub-streams correspond to predetermined view angles of the two eyes of the user, respectively.

19. The video display system of claim 18, wherein based upon a difference between the predetermined view angles, the emulation module temporarily utilizes the video information corresponding to the second sub-stream of the sub-streams to emulate the video information corresponding to the first sub-stream.

20. The video display system of claim 11, wherein the emulation module temporarily applies a shift amount to the video information corresponding to the second sub-stream of the sub-streams to emulate the video information corresponding to the first sub-stream.
